(19) United States
(12) Patent Application Publication
(10) Pub. No.: US 2015/0271146 A1
(43) Pub. Date: Sep. 24, 2015

(54) METHODS AND SYSTEMS FOR THE SECURE EXCHANGE OF INFORMATION

(71) Applicants: Brian Holyfield, New York, NY (US); Ronald Gutierrez, Astoria, NY (US)

(72) Inventors: Brian Holyfield, New York, NY (US); Ronald Gutierrez, Astoria, NY (US)

(21) Appl. No.: 14/437,742

(22) PCT Filed: Oct. 24, 2013
(86) PCT No.: PCT/US2013/066571

§ 371 Date: Apr. 22, 2015

Related U.S. Application Data
(60) Provisional application No. 61/718,082, filed on Oct. 24, 2012.

(51) Int. Cl. H04L 29/06

(52) U.S. Cl. CPC H04L 63/0428; H04L 63/061

(57) ABSTRACT

Computer implemented system and methods for the secure transfer of files or data between persons and groups using a third party host, wherein the host of the system, while storing the encrypted information for ultimate delivery to a recipient, cannot decrypt the file or data being transferred because it is not in possession of the entire encryption means.

### CROSS REFERENCE TO RELATED APPLICATIONS

This application claims priority to U.S. Provisional Patent Application Ser. No. 61/718,082 filed Oct. 24, 2012. The disclosure of U.S. Provisional Patent Application 61/718,082 is incorporated by reference herein in its entirety.

### FIELD OF THE INVENTION

The present invention relates to methods and systems for the secure transfer of files or data between persons or groups using a third party host wherein the host of the system cannot decrypt the file being transferred because it is not in possession of the entire encryption means.

### BACKGROUND OF THE INVENTION

The present invention generally relates to the field of secure file and data exchange. The need to exchange sensitive files or data is a common business problem that presents numerous challenges. For example, e-mail is inherently insecure as messages are transmitted and exchanged in plain-text. Additionally, most corporate e-mail systems place size restrictions on files that can be exchanged. Encrypted compressed or ZIP files are frequently blocked by corporate and anti-virus programs.

The challenges with secure file exchange become more complicated when a third party is used to facilitate the exchange. In many cases, the third party requires access to the confidential file or data being transferred. Standard commercial offerings designed for secure file exchange tend to be either too complex to set up or fail to provide true privacy. Encryption is commonly used for implementing protection over data being exchanged through a third party, but too often the encryption keys are managed by the service provider exposing stored files to access via server compromise or malicious insider. Furthermore, all too frequently, the sender and recipient must have a common pre-established way to calculate and/or exchange the encryption key and encrypt or decrypt the data.

A person may want to leverage the benefits of using a third party to facilitate the exchange without granting the third party access to the data being exchanged. Thus, the present invention is designed to overcome the need for a pre-established key exchange and provides a platform for facilitating the secure exchange of encrypted files or data without the need to grant the party hosting the platform access to encryption key.

### SUMMARY OF THE INVENTION

The present invention describes methods and systems which can be hosted by a third party allowing two or more parties to transfer encrypted data between each other. The system obviates the need for sender and recipient to pre-sharing encryption keys and sharing of encryption keys with the third party host.

The system generally comprises at least two users, at least one general purpose programmable computer, data or information for encryption, a server used to facilitate the exchange and designed to be hosted by a third party, a data repository (e.g. data store), and a network for data exchange and transmission. In one embodiment, the system may additionally comprise an Application Programming Interface (API) that allows users of the system to automate certain tasks to interact with the system.

In some embodiments, the third party hosted server may provide means for generating, for storing and for distributing part, but not all, of the key material used to derive the encryption keys used to encrypt and decrypt data exchanged through the system. The server may also provide a means to store the encrypted data waiting for retrieval by users of the system, as well as a storage location for meta-data associated with the data being exchanged (e.g., Server Data Store). This meta-data may include attributes like the size of the data, file names if the data is in the form of a file, and identity information relating to the person who sent the data and the intended recipient(s) of the data. Finally, the server may provide a means for authenticating users of the system before allowing access to the data being exchanged.

In some embodiments, users or the system may fall into one of two categories, registered users or unregistered users. Registered users may be defined as users that have deliberately enrolled with the system through a registration process and established credentials for authenticating to the system. In some embodiments, registered users may fulfill one of the following roles: sender, recipient, or requestor. A sender may be defined as a person, group, organization, or system sending data or information (e.g. data package) through the system to one or more recipients. A recipient may be defined as a person, group, organization or system that receives data or information through the system. A requestor may be defined as a person, group, organization, or system that requests data through the system from an un-registered user (referred to as a “UR Sender”).

Unregistered users may be defined as users that have not previously enrolled with the system and do not have established credentials for authenticating to the system. In some embodiments, unregistered users may fulfill one of the following roles: UR Sender and UR Recipient. UR Senders may be defined as an un-registered user acting as a sender (see above). For purposes of describing the system, UR Senders differ from normal senders (registered) in that the steps carried out within the system differ. A UR Recipient may be defined as an unregistered person, group, organization, or system that receives data through the system.

In some embodiments, the system may be used as a computer implemented method for securely transferring data between parties using a third party system host. In one embodiment, the method may comprise providing data for encryption, a data package sender, a data package recipient, a system host, a system host server, and a graphical user interface; generating a first secret and attributing said first secret to the data package; generating a second secret inaccessible to said system host; combining said first secret and said second secret to generate an encryption key, encrypting the data and uploading the data to the host server; and combining the first secret and second secret and reconstituting the encryption key to decrypt the data package. In another embodiment, the steps may comprise providing data for encryption, a data package requestor, a data package sender, a system host, a system host server, and a graphical user interface; at the system host generating a first secret and attributing said first secret to the data package; at the data package requestor generating a second secret inaccessible to said system host; at the data package sender combining said first secret and said second secret to generate an encryption key, encrypting the data package and uploading the data package to the host server; and at the data package requestor accessing the encrypted data package that has been uploaded to the system host server, retrieving the encrypted data package from the system host server, and reconstituting the encryption key from the first secret and second secret to decrypt the data package.

### BRIEF DESCRIPTION OF THE DRAWINGS

Representative embodiments of the invention are disclosed in more detail with reference to the following figures. Like reference numerals designate corresponding parts or steps throughout the different views.

FIG. 1 is a dataflow diagram of the systems for the secure transfer of files or data between persons or groups using a third party host according to one embodiment.

FIG. 2 is a dataflow diagram of the systems for the secure transfer of files or data between persons or groups using a third party host according to one embodiment.

FIG. 3 is a dataflow diagram of the systems for the secure transfer of files or data between persons or groups using a third party host according to one embodiment.

FIG. 4 is a diagram of an embodiment of the basic system architecture for the systems for the secure transfer of files or data between persons or groups using a third party host.

FIG. 5 is a dataflow diagram of the systems for the secure transfer of files or data between persons or groups using a third party host according to one embodiment.

### DETAILED DESCRIPTION OF THE EMBODIMENTS

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” or “in some embodiments” or “in a preferred embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The following two embodiments are intended to illustrate the general capabilities of the system. Exemplary technical details of how each step works are provided.

### FIRST EXAMPLE

### Sender Transmits Encrypted Data to a Recipient

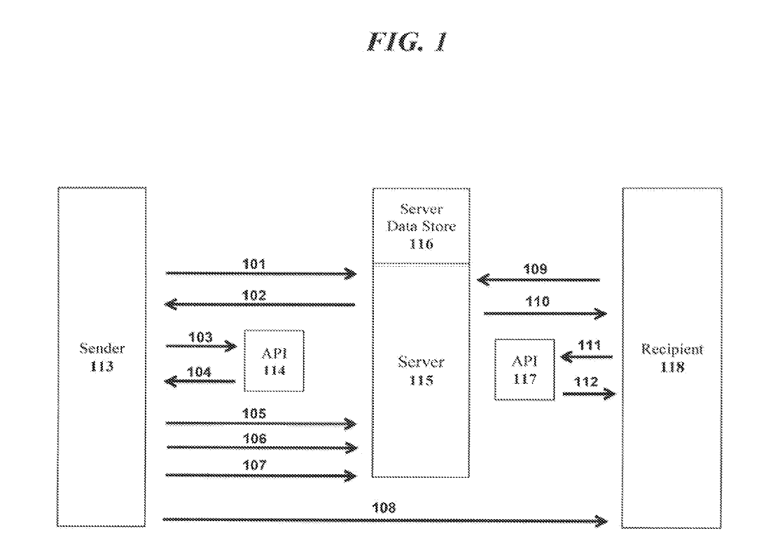

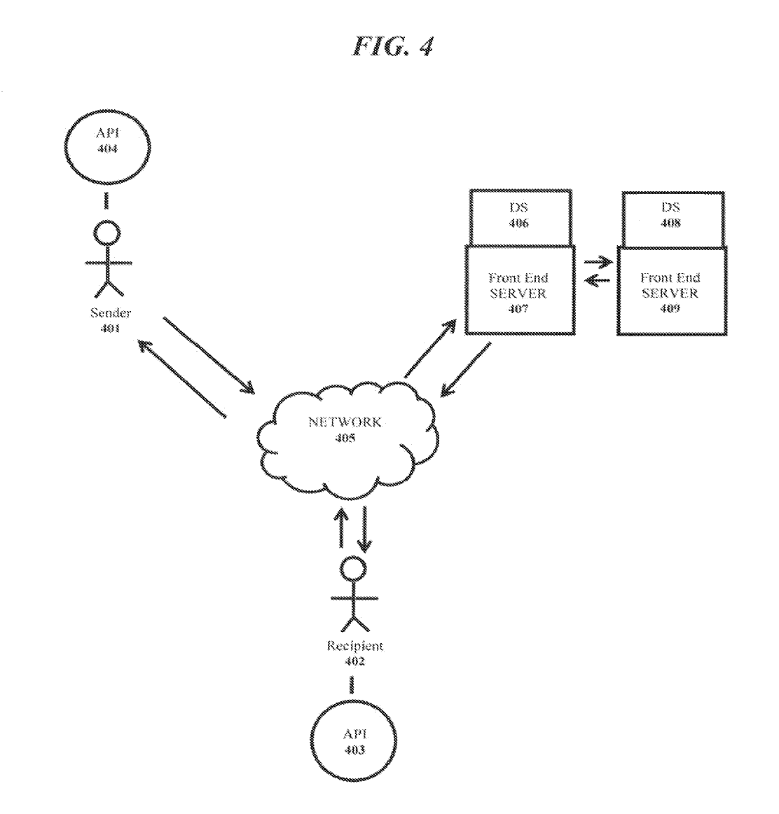

Referring to FIG. 1, in this example, a sender 113 transmits encrypted data to someone else using the system. The sender 113 in this example may be a registered user of the system while the recipient 118 may represent a registered user or an un-registered user. Both the sender 113 and recipient 118 may access the system from a programmable computing device, such as a desktop computer or smart phone. The system is accessible through a variety of means which would be understood by one of ordinary skill in the art. For example, a browser-based website and numerous Application Programming Interfaces (APIs) may be made available for use (see e.g., FIG. 1, reference numbers 114 and 117 and FIG. 4, reference numbers 404 and 403). Users of the system may be human or other computer programs that access the system. The APIs themselves provide a programmatic means to automate certain tasks within the system however their use is not required as most if not all of the described steps can be implemented independently (and, in fact, manually) by a user of the system. To the extent used, APIs may run locally on the computer that is used to access the system and may generate part of the key material used to derive the encryption keys used to encrypt and decrypt data exchanged through the system. The API may additionally, derive the entire encryption key that is used to encrypt the files or data being exchanged by combining a key material generated by the server platform (see e.g. FIG. 1, reference number 115 and FIG. 4, reference numbers 407 and/or 408) and key material generated by the API itself. And further, the API may encrypt and decrypt data or files using the derived encryption key.

In this example, the sender 113 will be authenticated before sending data through the system. Thus, the first step in this example is for the sender 113 to authenticate to the platform using previously established credentials. The credentials used to access the platform are initially established when a user registers with the platform. A variety of authentication credentials are supported for registered users, including but not limited to, a username and password. Every request to the server 115 must contain either the user's authentication credentials or an identifier that can be used to uniquely identify them. One of ordinary skill will understand that there are a variety of method by which the user may authenticate to the system as long as the authentication mechanism provides as means by which the user can identify themselves to the server 115. An embodiment of an authentication method and the authentication infrastructure is described below in more detail.

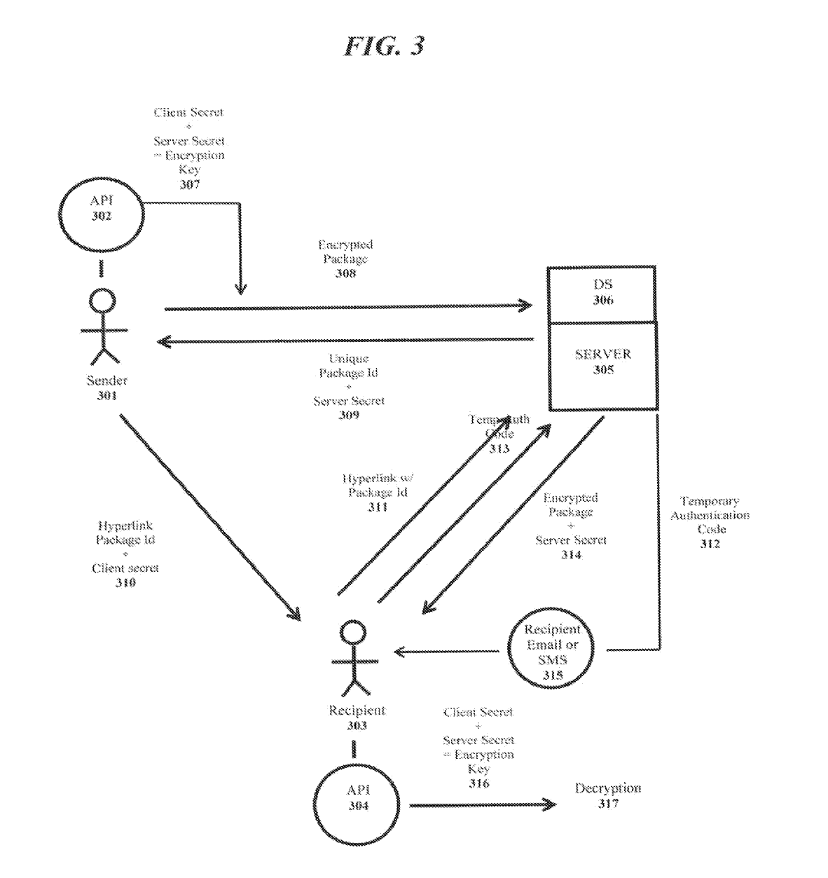

Referring now to FIG. 1 and specifically to reference numeral 101, once authenticated, a sender 113 may request that the system create a new empty package. In one embodiment, when the system creates a new package, it may assign at least two unique data attributes to the package, for example, a package identifier and server secret (see also e.g., FIG. 3, reference number 309). A package identifier of the present invention may be defined as unique value used to identify the package within the system. One of ordinary skill will understand that there are a variety of methods that are suitable to generate the package identifier. In one embodiment, the relationship of package to package identifier is 1:1. This value is not considered secret and can be used to request the package or refer to the package at any point in time. Because this value can be used to identify the package, the value may be relatively lengthy and adequately random such that it would be difficult for someone to easily guess a valid identifier. A server secret of the present invention may be defined as one of at least two secret values associated with the package that is used to derive the encryption key used to encrypt data associated with the package. One of ordinary skill will understand that there are a variety of methods that are suitable to generate the server secret. In one embodiment, the server secret may be generated using a cryptographically secure mechanism (such as a cryptographically secure pseudo random number generator). Once the server secret is generated, it should only be disclosed or shared with the owner of the package (the sender) or the intended recipients of the package (see also e.g., FIG. 3, reference number 309).

With continued reference to FIG. 1 and specifically to reference number 102, once a new package is created, the server 115 may send the package identifier and the package server secret to the sender 113 and the sender may add encrypted data to the package and specify one or more recipients 118 for the package. The order in which these two steps occur is not critical and each of these steps can be performed multiple times. For example, a user may add a single encrypted data element to the package and a single recipient 118; add multiple encrypted data elements and a single recipient 118; add a single encrypted data element and multiple recipients 118; or add multiple encrypted data elements and multiple recipients 118.

As shown in FIG. 1 and specifically at reference numbers 103 and 104, before the sender 113 can add encrypted data to the package, the sender 113 may generate a second secret value referred to as the client secret which may be combined with the server secret to derive the actual encryption key used to encrypt the data that is to be sent to the recipient (see also e.g., FIG. 3, reference number 307). In a preferred embodiment, unlike the server secret, the client secret is not known by the server and should never be shared with the server 115. The inaccessibility of the client secret by the server 115 is designed to prevent the operator of the server 115 from recalculating the encryption key and decrypting the sender's encrypted data.

The user encrypts the data they wish to send through the system using an encryption key derived by combining the client secret and server secret in this embodiment (see also e.g., FIG. 3, reference number 307). One of ordinary skill will understand that there are a variety of ways the exact calculation is used to derive the encryption key. In one embodiment, both the client secret and server secret are required to derive the key and the calculation used to derive the key is known by the recipients 118. For example, in one embodiment of the invention, a Password-Based Key Derivation Function (PBKDF) is used to derive the encryption key using the client secret and server secret. Most PBKDFs apply a pseudorandom function, such as a cryptographic hash, cipher, or HMAC to two inputs (a password or passphrase along with a salt value) and repeat the process many times to produce a derived key, which can then be used as a cryptographic key in subsequent operations. In this case, the client secret could be used as the password or passphrase and the server secret could be used as the salt value. In another embodiment, the client secret and server secret could be concatenated together and used as the actual passphrase for OpenPGP symmetric encryption.

In some embodiments of the invention, both the user and recipient(s) access the system using a common interface, such as website, which invokes an API that runs locally on the sender's 113 computer to encrypt the data (see also e.g., FIG. 3, reference numbers 302 and 304). The API may accept the client secret, server secret, and data to encrypt, and return the encrypted data to the sender. The API may include logic to calculate the encryption key in the same manner and use the same encryption algorithms for consistency. Referring now to reference number 105 of FIG. 1, after the data has been encrypted by the user, it can be uploaded to the server 115 and associated with the previously created package.

Once the user has added encrypted data to the package, they may specify 106 one or more recipients 118. One of ordinary skill will understand that there are a variety of mechanisms that could be used to identify recipients as long as each recipient is uniquely identified. In one embodiment of the invention, recipients are identified by their email address which is used to identify and authenticate (see also e.g., FIG. 3, reference numbers 312 and 313) the recipient before the server 115 permits access to the package. The specific method by which the recipient is authenticated is also not critical to the invention provided that they can be identified with relative confidence. For example, in one embodiment the user might be authenticated using as previously established user name and password combination, or might be authenticated by an authentication provider using a distributed authentication protocol like OpenId or OAuth. Additionally, the server 115 may wish to offer stronger levels of authentication, such as multi-factor authentication, if such means are available. In one embodiment, the server 115 could allow the sender to specify the mobile phone number of each recipient so that an authentication code can be sent to their mobile device to confirm their identity.

Referring now to reference number 107 of FIG. 1, once the sender 113 has added at least one encrypted data element to the package and at least one recipient, they can instruct the server 115 to finalize the package 107. Once the package is finalized it is made available by the system to the recipients 118 of the package. Before or after the package is finalized, the system may also offer additional configuration options that can be specified by the sender with regards to the package. For example, the system may permit the sender to dictate how many days the package is available to recipients before it is automatically deleted and could provide capabilities to notify the user when the package is accessed.

Once the package has been finalized, the sender 113 may notify each recipient 118 that the package is available and also provide them with the necessary information needed to access the package 108 (see also e.g., FIG. 3, reference number 310). The mechanism for providing this information to recipients may be a hyperlink to the server 115 that can be used to access the package (see e.g., FIG. 3, reference number 310). The URL for accessing the package may be specifically crafted by the user and may contain the package identifier, which is used by the server 115 to determine which package the recipient 118 is requesting.

In addition to the package id, the recipient 118 will also need to have the correct client secret that was generated by the sender in order to re-calculate the correct decryption key for the encrypted package data (see e.g., FIG. 3, reference number 310). An important aspect of this invention is that the server 115 never has knowledge of the client secret for any package in one embodiment, in order accomplish this, the client secret is not embedded within the hyperlink that the sender provides to the recipient as a standard HTTP request parameter. HTTP request parameters are passed to the server when the link is clicked and can be read by the server 115. Instead, a URL fragment identifier is used within the hyperlink to pass the client secret. The fragment identifier may be introduced by a hash mark (#) within a URL and is an optional last part of a URL. Fragment identifier values, while included in the URL, are not transmitted within the HTTP request to the server when the link is clicked from a browser. This method allows the client secret to be embedded within the link and accessible to the recipient while not disclosing it to the server 115 when the link is clicked. An example of a URL including as package identifier and client secret is shown below.
http://server/download?packageId=92837892#clientSecret=8dks021sjdu02ksd0

Referring now to reference number 109 of FIG. 1, in this example, the recipient 118 clicks the hyperlink and is directed to the server 115 (see also e.g., FIG. 3, reference number 311). The server 115 looks up the package associated with the specified package identifier and, if found, the server 115 retrieves the list of recipients associated with the package. Before allowing access to the package, the recipient 118 may be required by the system to identify themselves. In an embodiment where each recipient 118 had been identified by their email address, the recipient may provide their email address to the server 115 and authenticate, using, for example, a previously established username and password or by other means. In cases where the recipient is unknown to the system (e.g., an un-registered user) the system may send a temporary password to the recipient's email address and require entry of the password before allowing access (see e.g., FIG. 3, reference numbers 312 and 313). Once the recipient 118 has authenticated, the system may allow recipient access the stored data associated with the package 110. The stored data may include the encrypted data that was uploaded by the sender and the server secret.

Once the recipient 118 has been granted access to the encrypted data, they must be able to decrypt the data in order to make use of it. In order to decrypt the data, the same encryption key used to encrypt the data may be re-calculated by the recipient 118 by combining the client secret and server secret 111 and 112 (see also e.g., FIG. 3, reference number 316). For example, where the recipient 118 is accessing the system using an API running locally on the recipient's computer, the recipient can re-calculate the encryption key and decrypt the data using the API.

In one embodiment, the URL used in the previous example is used to access the system using a standard web browser and a browser-based API written in JavaScript. This API is included as part of the web page used to access the package and runs locally within the web browser on the recipient's computer. The browser API re-calculates the decryption key using the server-supplied server secret and the client secret, which is read from the URL fragment identifier in the browser address bar. Once the recipient has re-calculated the encryption key, the data is decrypted and saved locally on the recipient's computer.

### SECOND EXAMPLE

### User Requests Encrypted Data from Someone

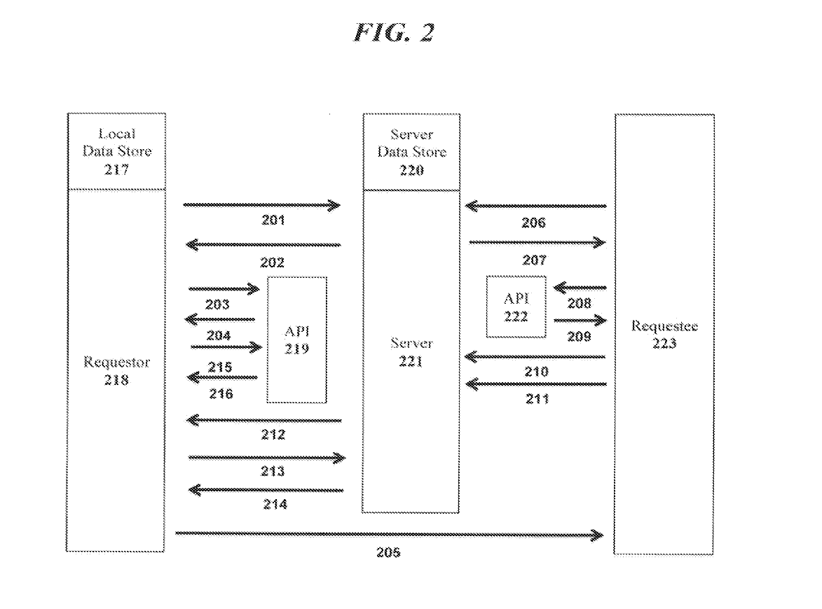

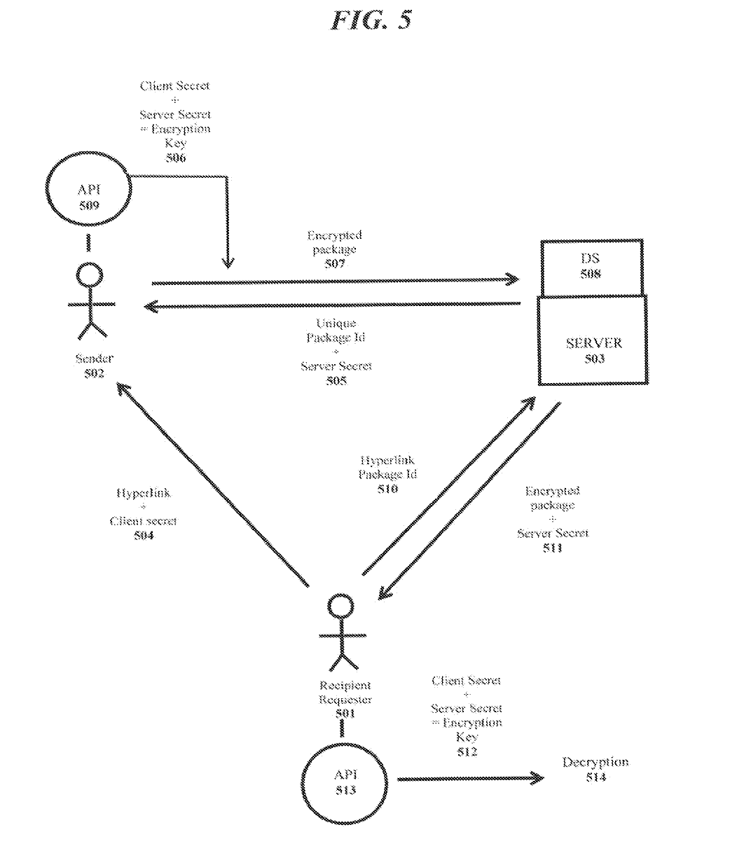

Referring to FIG. 2, another exemplary use case of the system is for a user to request encrypted data (a package) from someone else using the system in this embodiment, the sender may be unregistered (UR sender). The user requesting the data is referred to as the requestor and the party they are requesting data from is referred to as the UR sender. In one embodiment, the requestor must be registered with the system to request a package. The requestor may access the system from a computing device, such as a desktop computer or smart phone. The system may be accessed either through a standard web page interface using a web browser, or programmatically using a web service exposed by the server. While the requestor in many cases is a human, the requestor could also be another process that accesses the system through an Application Programming Interface (API) that is made available as part of the system (see e.g., FIG. 2, reference numbers 219 and 222; FIG. 5, reference numbers 509 and 513).

In one embodiment, the requestor must be authenticated before requesting a package. Referring now to FIG. 2 and specifically to reference numbers 201 and 202, once authenticated, the requestor 218 (reference number 501 in FIG. 5) may ask the system to create a package request. In one embodiment, the instruction to create a new package request requires the identity of the requestee or UR sender 223 (reference number 502 in FIG. 5). For example, when the system creates a new package request, it assigns at least three data elements to the package request: a request identifier, request owner, and UR sender 223. A request identifier may be defined as a unique value used to identify the package request within the system 202. The same principles previously described for generating a package identifier value hold true for this value. A request owner may be defined as a unique identifier associated with the requestor 218. In one embodiment, the email address of the requestor 218 may be used A UR sender 223 may be defined as the identity of the person from whom the package is being requested. Like the recipient of a package, one of ordinary skill will recognize that there are a number of ways the system might identify the UR sender 223, as long as each UR sender 223 uniquely identified. In one embodiment, the email address of the person from whom data is being requested would be used. In one embodiment, the request identifier, the identity of the requestor 218, and the identity of the UR sender 223, are stored in a server data store 220 (see also e.g., FIG. 4, reference numbers 406 and/or 408). Once the new request is created, the server 221 may provide the request identifier back to the requestor 202.

Referring now to reference numbers 203 and 204, in one embodiment, the requestor 218 generates a client secret that will be used by the UR sender 223 to calculate the encryption key for encrypting the data they send to the requester 218. Like the client secret used when sending data, the client secret is known only by the requestor 218 and should never be shared with the server 221. The requestor 218 may store the client secret and request identifier locally in the user data store 220 so it can be accessed when receiving files from the UR sender 223. One of ordinary skill will recognize that there are a number of mechanisms by which the client secret can be stored as long as the requestor 218 may retrieve this value from the local data store 220 based, for example, on the request identifier.

Referring to reference number 205, the requestor 218 may next notify the UR sender 223 of the package request and provide them with the necessary information needed to access the system via network for sending data. In one embodiment, a hyperlink to the server 221 is constructed by the requestor 218 and transmitted to the UR sender 223. The URL may include the request identifier which is be used by the server 221 to retrieve information associated with the request. In one embodiment, the request identifier is passed as a URL parameter. The requestor 218 may also share the client secret with the UR sender 223 (see also e.g., FIG. 5, reference number 504). Like the method used for constructing a link to access a package, the client secret may be appended to the URL as a fragment identifier as to avoid being transmitted to the server when the link is clicked, yet still allowing the link to be used for communicating the client secret to the UR sender 223. An example of a URL including a request identifier and client secret is shown below.
http://server/send?requestId=92837892#clientSecret=8dks021sjdu02ksd0

In this example, as indicated by reference number 206, the UR sender 223 may click the hyperlink which directs them to the server 221. The server 221 look ups the request associated with the specified identifier and, if found, will authenticate the UR sender 223. The method used to authenticate the UR sender 223 is not critical to the invention. However, in one embodiment the system authenticates the UR sender 223 by sending them a temporary password to the UR sender's 223 email address requiring entry prior to access.

Once the UR sender 223 is authenticated, the server 221 may allow them to create a new package for the requestor 218. In one embodiment, the newly created package may have attributes assigned to it, such as for example, a package identifier, a server secret, recipient, and reply-from. (see also e.g., FIG. 5, reference number 505). The package identifier may be defined as a unique value that is used to identify the package within the system. The same method and principles previously described for generating a package identifier value apply for this value. The server secret may be defined as one of two or more secret values associated with the package that is used to derive the encryption key used to encrypt data associated with the package. The same method and principles previously described for generating a package server secret apply for this value. The recipient may be a single recipient (the requestor) that is automatically added to the package. In one embodiment, unlike the workflow when a registered system user is sending files to someone, a UR sender 223 may not have the option to specify recipients. In this example, packages they create have only a single recipient, which is the requestor 218. The reply-from attribute indicates that the package was created in response to a previously sent package, and that the client secret from the previously sent package should be used for this package. This value of the reply-from attribute in this case is set to the request identifier from the package request.

Referring to reference numbers 207, in this embodiment, once the new package is created, the server 221 will provide the package identifier and the server secret back to the UR sender 223 (see also e.g., FIG. 5, reference number 505). The UR sender 223 may then add encrypted data to the package. Referring, to reference numbers 208 and 209, before adding data elements to the package, the UR sender 223 must encrypt the data using an encryption key derived by combining the server secret and the client secret from the package request, which was generated by the requestor 218 (see also e.g., FIG. 5, reference number 506). The same principles previously described with respect to calculating the encryption key when sending an encrypted file hold true at this case.

In one embodiment, both the UR sender 223 and requestor 223 will be accessing the system using a common interface, such as an API (see e.g., FIG. 2, reference numbers 219 and 222; FIG. 5, reference numbers 509 and 513). The API will ensure that the encryption key and encryption algorithms used to encrypt the files or data are calculated uniformly when encrypting the data and decrypting the data. After the data has been encrypted by the UR sender 223, the encrypted data may be uploaded to the server 221 and associated with the package 210.

Once the UR sender 223 has added at least one encrypted data element to the package, they can instruct the server 221 to finalize the package, which means the server 221 will make the package available 211 to the requester 218. The server sends a notification to the requestor indicating that the UR sender has created a package for them, along with a link that can be used to access the package which includes the package identifier 212. Unlike when as registered user sends a package, the UR sender in this case does not need to manually email a link to the requestor 218 since the client secret used for the packages is the same client secret that was generated by the requestor 218 (which is already known and stored by the requester on their computer). In such cases, the system is able to automatically send a link to the package. The URL may contain only the package identifier passed, for example, as a URL parameter, and no client secret.

Once the notification is received by the requestor 218, they can click the link to access the package 213. If the requestor 218 is authenticated, the server would ensure that the requestor is listed as a valid recipient for the package and allow access 214 (see also e.g., FIG. 5, reference number 510). If not already authenticated, the server 221 would require that the requestor identify themselves and authenticate to the system.

Once this authorization check has been performed, the server 221 will allow the user to access data associated with the package 214 (see also e.g., FIG. 5, reference number 511). In one embodiment, the stored data includes: (1) the encrypted data that was uploaded by the UR sender 223; (2) the server secret associated with the package; and (3) the reply-from value that indicates the request identifier associated with this package. The server 221 should supply the reply-from attribute to the requestor since the UR sender 223 did not provide a client secret to the requester 218. It is assumed that the requester 218 previously saved a client secret associated with the package request, so the requester 218 will be able to look up this value locally.

As shown in reference numbers 215 and 216, once the requestor 218 has access to the encrypted data associated with the package, they will download the data and decrypt it (see also e.g., FIG. 5, reference number 512). As with the previous example, the same encryption key used to encrypt the data must be re-calculated to decrypt the data. The same combination of the client secret and server secret is used to re-calculate the key. The user may be accessing the system using as set of common APIs that can be run locally on the user's computer and are able to easily recalculate the key and decrypt data provided that the correct client secret and server secret is provided. Once the requestor 218 has re-calculated the encryption key, the data is decrypted and saved locally on their computer.

It should be appreciated by those of ordinary skill in the art that the systems and methods of the present disclosure may be implemented on any computer network (see e.g., FIG. 4, reference number 405). Methods and devices for providing network data transmission are well known in the art.

Embodiments may include program products comprising non-transitory machine-readable storage media for carrying or having machine-executable instructions or data structures stored thereon. Such machine-readable media may be any available media that may be accessed by as general purpose or special purpose computer or other machine with a processor. By way of example, such machine-readable storage media may comprise RAM, ROM, EPROM, EEPROM, CD-ROM or other optical disk storage, magnetic disk storage or other magnetic storage devices, or any other medium which may be used to store desired program code in the form of machine-executable instructions or data structures and which may be accessed by a general purpose or special purpose computer or other machine with a processor. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the present invention have been described in the general context of method steps which may be implemented in one embodiment by a program product including machine-executable instructions, such as program code, for example in the form of program modules executed by machines in networked environments. Generally, program modules include routines, programs, logics, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

As previously indicated, embodiments of the present invention may be practiced in a networked environment (see e.g., FIG. 4, reference number 405) using logical connections to one or more remote computers having processors. Those skilled in the art will appreciate that such network computing environments may encompass many types of computers, including personal computers, hand-held devices, multi-processor systems, microprocessor-based or programmable consumer electronics, network PCs, minicomputers, mainframe computers, and so on. Embodiments of the invention may also be practiced in distributed and cloud computing environments where tasks are performed by local and remote processing devices that are linked (either by hardwired links, wireless links, or by a combination of hardwired or wireless links) through a communications network. In a distributed computing environment, program modules be located in both local and remote memory storage devices.

It should be noted that although the discussions herein may refer to a specific order and composition of method steps, it is understood that the order of these steps may differ from what is described. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present invention. Such variations will depend on the software and hardware systems chosen and on designer choice. It is understood that all such variations are within the scope of the invention.

It should be understood that the systems and methods of the present invention may utilize and operate over a wireless network. A wireless network, as used herein, may be configured to couple devices used by system users (e.g. mobile devices) and its components with network. Wireless network may include any of a variety of wireless sub-networks that may further overlay stand-alone ad-hoc networks, and the like, to provide an infrastructure-oriented connection for system devices. Such sub-networks may include mesh networks. Wireless LAN (WLAN) networks, cellular networks, and the like.

Wireless network may further include an autonomous system of terminals, gateways, routers, and the like connected by wireless radio links, and the like. These connectors may be configured to move freely and randomly and organize themselves arbitrarily, such that the topology of Wireless network may change rapidly.

Wireless network may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for system devices, such as mobile devices with various degrees of mobility. For example, Wireless network may enable a radio connection through a radio network access such as Global System for Mobile communication (GSM), General Packet Radio Services (GPRS), Enhanced Data GSM Environment (EDGE), Wideband Code Division Multiple Access (WCDMA), and the like. In essence, Wireless network may include virtually any wireless communication mechanism by which information may travel between a computing device, mobile device, network, and the like.

System components may also communicate over a network (see e.g., FIG. 4, reference number 405) configured to couple at least some components of system with each other, including, server and client devices and through Wireless network to mobile devices if applicable. Suitable networks are enabled to employ any form of computer readable media for communicating information from one electronic device to another. Also, networks may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, suitable networks include any communication method by which information may travel between the system server, client devices, and other computing devices.

Devices that may operate as the third party server include personal computers, desktop computers, multiprocessor systems, microprocessor-based or programmable consumer electronics, network PCs, servers, and the like.

Suitable data stores (see e.g., FIG. 4, reference numbers 406 and 408) include but are not limited to data repositories such as databases but may also include flat files that can store data. Some data stores represent data in only one schema while other data stores use several schemas for this task. Examples, of suitable data stores include RDBMS-based data stores like MySQL or open source products, such as PostgreSQL. The data store may be a cloud based solution. For example, Amazon RDS may be used to power the back-end database layer of the platform. Amazon RDS provides a reliable and scalable MySQL database that can be consumed by all server platform components. In one embodiment the database infrastructure comprises an Amazon RDS instance and data store for all app-related information.

Suitable client devices may generally include a processing unit in communication with a mass memory via a bus. Suitable client devices also include a power supply, one or more network interfaces, an audio interface, a display, a keypad, an illuminator, an input/output interface, and a haptic interface. Suitable power supplies provide power to client device. A rechargeable or non-rechargeable battery may be used to provide power. The power may also be provided by an external power source, such as an AC adapter or a powered docking cradle that supplements and/or recharges a battery.

Suitable client devices may optionally communicate with a base station, or directly with another computing device. Network interfaces includes circuitry for coupling client device to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax). SIP/RTP, and the like.

Suitable client devices may further include additional mass storage facilities such as CD-ROM/DVD-ROM drive and hard disk drive. Hard disk drive is utilized by client device to store, among other things, application programs, databases, and the like. Additionally, CD-ROM/DVD-ROM drive and disk drive may store cookies, data, images, or the like.

Mass memory within the context of suitable client devices includes a RAM, a ROM, and other storage means. Mass memory illustrates another example of computer storage media for storage of information such as computer readable instructions, data structures, program modules or other data. Mass memory stores a basic input/output system (“BIOS”) for controlling low-level operation of client device. The mass memory also stores an operating system for controlling the operation of client device. It will be appreciated that this component may include a general purpose operating system such as a version of UNIX, or LINUX™, or a specialized client communication operating system such as Windows Mobile™, or the Symbian® operating system. The operating system may include an interface with a Java virtual machine module that enables control of hardware components and/or operating system operations via Java application programs.

Programs may also include computer executable instructions which, when executed by client device, transmit, receive, and/or otherwise process messages and enable telecommunication with another user of another client device. Other examples of application programs include calendars, contact managers, task managers, transcoders, database programs, word processing programs, spreadsheet programs, games, CODEC programs, and so forth. In addition, mass memory stores browser, and messenger.

Suitable client devices may additionally maintain browser functionality. Browsers may be configured to receive and to send web pages, forms, web-based messages, and the like. Browser may, for example, receive and display (and/or play) graphics, text, multimedia, audio data, and the like, employing virtually any web based language, including, but not limited to Standard Generalized Markup Language (SGML), such as HyperText Markup Language (HTML), a wireless application protocol (WAP), a Handheld Device Markup Language (HDML), such as Wireless Markup Language (WML), WMLScript, JavaScript, and the like. Browser may also be configured to receive, store, and/or provide data. For example, in one embodiment, browser may receive and store client device data in the form of a cookie, or the like.

Suitable client devices may additionally maintain messenger functionality. Messenger may be configured to initiate and manage a messaging session using any of a variety of messaging communications including, but not limited to email, Short Message Service (SMS), Instant Message (IM), Multimedia Message Service (MMS), interact relay chat (IRC), mIRC, and the like. For example, in one embodiment, messenger 272 may be configured as an IM application, such as AOL Instant Messenger, Yahoo! Messenger, NET Messenger Server, ICQ, or the like. In another embodiment, messenger may be a client application that is configured to integrate and employ a variety of messaging protocols.

The system and methods described herein may use third party IT infrastructure services, for example, Amazon Web Services (“AWS”). In one embodiment, the Amazon Elastic Computer Cloud (“Amazon EC2”) may be used to host the application, for example, on a Linux server image. Other cloud service providers, such as Rackspace or Google, may also be used for hosting such service.

### Logical Object Model

The data store (see e.g., FIG. 4, reference numbers 406 and/or 405 used in the system platform may be based on a simple object model as described in the embodiment below. For example, information and data such as decryption limits, authentication requirements, user information, recipient information, and package information may be stored, for example, in Object Model storage. Mechanisms other than Object Model storage, however, may be used to implement user preferences.

A user object may include basic information identifying each individual using the system. The system may employ one or more user types. Different user types may be represented by the same core user object within the systems data model (an attribute of the user defines whether they are a full user or not). In one embodiment, for example, two user types may be used, a registered user and an un-registered user.

A registered user may be defined as one who has enrolled in the system as a customer. Authentication for registered users may occur by various methods, including but not limited to OpenId, OAuth or directly using the system-managed login mechanism (with, for example, a username and password). Registered users may also be associated with a corporate entity or may be stand-alone (individual) users and have full access to all system features and capabilities and limited only by the usage tier assigned to them.

An un-registered user may be someone who has received a package from a registered user or who has had a request for files sent to him/her by a registered user, such as the UR sender (see e.g., FIG. 2, reference number 223). Un-registered user access may be limited to exchanging data with the registered user(s) who initiate the data exchange. Un-registered users may additionally be restricted from making requests for files from other users.

Registered users may optionally belong to an organization. An organization object may represent a collection of users that all belong to the same managed entity (such as a corporate customer). Users that belong to an organization may be collectively billed through the organization and can be restricted from certain features as defined within the organization's policy configuration.

The system may use a package object to represent a set of one or more related data elements that are being exchanged within the system. The package may include an owner (may be a reference to the user object associated with the package creator), one or more data objects, one or more recipients, and other attributes specific to the package. For example, the package may include an availability window that represents the number of days for which the data is retained within the system, and other attributes that can be used to determine the package status and the date/time of access by each recipient.

Data objects may represent encrypted files or data blobs associated with a package. Each data object may contain metadata about the un-encrypted data (file name, message size, etc) and may also be used to map the data within the database to a physical file on a storage medium, such as the server file system or a separate storage tier, such as within Amazon Simple Storage Service (S3) or an Amazon Elastic Block Storage (EBS) volume.

Packages may contain one or more recipient objects representing a user(s) who is to receive a package. The recipient may include a reference to a user object and/or one or more confirmation objects used to track each time the data is accessed by the recipient. In another embodiment, a special “Undisclosed Recipient” user may be assigned as the sole recipient for packages where the sender does not want to disclose the identity of the recipient to the system. For these cases the link to access the package may be un-authenticated (anyone with the link can access the package) or authenticated through a more rudimentary means, such as with a password. The recipient object may comprise attributes to indicate delivery of the package such as for example an SMS number (may be provided by the sender). The recipient object will also include one or more confirmation objects to track the date/time, source IP address, and data object accessed by the recipient.

### Sender and Recipient Accessing the System Through a Web Based Application

A web application may manage and coordinate interactions between all users of the system and may fulfill all requests issued by the client. There are a number of functions that the server (see e.g., FIG. 1, reference number 115; FIG. 2, reference number 221; FIG. 3, reference number 305; FIG. 4, reference number 405; FIG. 5, reference number 503) may fulfill such as, fur example, sending or receiving files, determining the status of sent files, and registering with the file sharing system. The web application infrastructure may be comprised of a physical server or virtual machine running a web server and an application engine. For example, one embodiment may run the web application using a combination of the Apache Web Server and Tomcat Servlet Engine running on the Amazon EC2 virtual computing platform. Any underlying operating system can be used for the server. In one embodiment, the Ubuntu Linux server platform can be used as the server operating system. Finally, pages may require transport layer encryption, such as Secure Sockets Layer (SSL).

In this embodiment, a system client may be accessible as a browser-based web application. All user interface code may be written using a combination of HTML, CSS and JavaScript and can invoke additional browser plug-ins, such as the Java Runtime (via a Java Applet) to perform client-side processing tasks. In one embodiment, a Java Applet for client-side cryptographic operations and file management is used. The applet may be signed using an SSL certificate issued to the system host or publisher from a trusted Certificate Authority.

A user first may visit the web page using a web browser executing on a computing device, such as a desktop computer, lap top computer, or smart phone. Depending on the type of user (registered vs. un-registered), the user may provide a variety of input data into the web page. For example, the web page may display a form into which the user may type text to be encrypted or which allows the user to select a local file that is to be encrypted. Optionally, the user may also input, through the web page, certain limits on how long the data will be accessible for and/or authentication data used to authenticate recipients before allowing access. The user may enter the plain text in any manner, such as by typing the text or pointing the web browser to a file containing the text or binary data.

The system of the present invention may also include a back-end storage mechanism where files are stored. Since the web application can run on any number of individual web server instances, they may share access to a common and synchronized file repository. Various file storage platforms may be used including without limitation Amazon S3, NFS, or GlusterFS to expose the storage system to multiple web servers. In one embodiment, the storage structure infrastructure may comprise Amazon EC2 virtual machines running Ubuntu and GlusterFS, using Amazon EBS volumes for EC2 persistent storage. The storage structure may additionally operate as a single instance or alternatively a fully redundant multi-node cluster.

In one embodiment, Amazon RDS may be used to power the back-end data store layer of the platform. Amazon RDS provides a reliable and scalable MySQL database that can be consumed by all server platform components. In one embodiment that database infrastructure comprises an Amazon RDS instance and data store for all app-related information.

When a user sends data or requests data from another user, the system may allow them to choose the authentication means to be used before allowing the other party access to the system (referred to as the “authentication model”). The authentication model determines how the recipient will authenticate to get access to the system. Example authentication models include but are not limited to, Email Verification, SMS Verification and Pre-Shared Password.

A variety of authentication systems may be used by the server to enforce each authentication model. Suitable authentication systems of the present invention can include a username and password or passphrase combination, a system generated password or passphrase, third party authentication providers based on open authentication protocols such as OAuth or OpenId (and the like) or some combination thereof. Common examples of third party authentication providers include Google's OAuth service, Twitter's OAuth service, Gmail's OpenID service, and Facebook's Facebook Connect Service. Authentication may also occur via cell phone. Cell phone authentication systems may require the sender to enter the viewer's cell phone number. Then a password or passphrase run be sent to the recipient's cell phone number when they attempt to access the package, in response to which the recipient may enter the password or passphrase to verify their identity. Email-based authentication is similar to cell phone authentication except the code would be sent via email instead of by SMS. Physical authentication devices can also be used which include a variety of hardware based solutions such as biometric scanners and one-time password generators. In short a wide variety of methods can be used to authenticate viewers and this invention is flexible enough to allow for the future integration of new methods.

Authentication models may be enforced differently based whether the recipient is a registered user or an un-registered user. For example the system may always want to require that a user provide their unique username and password for accessing the system if they are a registered user, whereas this would not be possible for un-registered users. In the case a an un-registered user, the system instead could generate a temporary passcode and send the passcode either to the un-register user's email address (for email verification) or to their mobile phone (for SMS verification) in order to authenticate. In addition to these authentication requirements, the system may also require verification that the user has the correct key code (not visible to the server). Verification of the key code may be performed by having the recipient calculate a cryptographic hash their key-code, and comparing the hash to one stored by the system. If this additional step were to be used, then the sender would have needed to provide a hash of the key code to the server so that it can be used for verification.

### Sender Accessing the System Through a Desktop Email Client

In one embodiment, the system may be accessible through another application, such as a desktop email client, for example, by way of an application programming interface that runs locally on the sender's machine. The email client may invoke the API through a plug-in, winch may be developed specifically for the email client that allows the package sender to interact with the system much in the same way they would typically send a normal email message.)

For example, if the sender was to transmit a file through the system, they may attach a file to a new email message using the email client. The plug-in would intercept the action used to attach the file and, instead of attaching the file to the email message, the plug-in would invoke the API and use the API to create a new package, encrypt the desired file and upload the encrypted file to the system. In one embodiment, a link required to access the package would then be inserted automatically into the email message by the plug-in.

The recipient of the package would still be able to access the system through another interface, such as by way of a web application as noted in the previous embodiment. A desktop email client may also be used to generate a new package request by way of an API in much the same way as described for sending files above. Multiple embodiments of the system can be compatible with each other as long as they use the same method for deriving the encryption key.

### Key Derivation Examples

In some embodiments, encrypted data associated with a package is encrypted on the user's computer before being submitted to the server. Encryption may be performed using an encryption engine that executes locally on the user's computer, either by a client application or within the users web browser. For example, in one embodiment, the encryption engine is implemented using JavaScript within the webpage. Mechanisms other than JavaScript, however, inn be used to implement the encryption engine.

In another embodiment, a client-side Java Applet may be used for performing all encryption and decryption and local key management. The Java Applet may also make use of one or more well-known cryptographic libraries to perform encryption, such as the open source Bouncy Castel library. Furthermore, an encryption key of any size may be used. The encryption engine may select the key in any way, and may use any encryption technique to produce the encrypted message from the plain text, provided that the materials needed to generate the encryption and decryption keys are not known by the server. For example, in one embodiment, the OpenPGP (“Pretty Good Privacy”) specification is used for performing the encryption and decryption according to the specification dictating symmetric (passphrase) based file encryption. The passphrase used to encrypt and decrypt each file may be derived by a combination of the client secret and the server secret.

An example of how the client secret is generated is as follow: Random data of any size may be generated. For example, 256 bits of random data (32 bytes) may be generated by the system client using a cryptographically secure random number generator (e.g., Java Secure Random). The 256-bit value may then be hex encoded so that it can be used as part of the OpenPGP passphrase.

An example of how the server secret is generated is as follows. 256 bits of random data (32 bytes) may be generated by the system server using a cryptographically secure random number generator (eg./dev/urandom). An HMAC of the random value calculated using a private key stored on the server may then be used to produce the actual server secret value that is provided to the client to be used in this embodiment as part of the OpenPGP passphrase. In this embodiment, only the randomly generated data (not the actual computed HMAC output) can be stored in the data store, along with the key identifier or the private server key used to produce it. This would result in the need for knowledge of bath the random value from the data store and the server signing key in order to generate the server secret.

In one embodiment, users that are part of an organization (a corporate subscription, for example) may also be subject to an additional step that allows the server to act as an escrow agent for client secrets. This embodiment makes use of an additional asymmetric (public/private) key pair, of which only the public key is known by the server. Each time a package is created by an organization user, the system provides the organization's pubic key to the user so that they can encrypt the generated client secret with the organization's public key. In this embodiment, since the system only has knowledge of the public key for the organization and not the private key, the system is unable to ever decrypt the submitted client secret values however it can retain them for later retrieval by an authorized organization administrator should they request it. The purpose of this additional step would be to allow for the organization to have access to all data sent through the system while still preventing the system from having the means to decrypt the data.

While the present invention has been described herein with respect to the exemplary embodiments, it will become apparent to one of ordinary skill in the art that many modifications, improvements and subcombinations of the various embodiments, adaptations and variations can be made to the invention without departing from the spirit and scope thereof.

What is claimed is:

1. A computer implemented method for securely transferring data between parties using a third party system host comprising the steps of:
providing data for encryption, a data package sender, a data package recipient, a system host server, and a user interface;
at the system host server generating a first secret and associating said first secret to the data package;
at the data package sender generating a second secret inaccessible to said system host server;
at the data package sender combining said first secret and said second secret to generate an encryption key, encrypting the data and uploading the data to the system host server; and
at the data package recipient after receiving the first secret from the system host server and second secret from the package sender, combining the first secret and second secret and reconstituting the encryption key to decrypt the data package.

2. The method of claim 1 comprising the additional step of at the system host server assigning a package identifier to the data package and returning said first secret and package identifier to the data package sender.

3. The method of claim 2 comprising the additional step of at the data package sender transmitting said package identifier and second secret to the data package recipient.

4. The method of claim 3 wherein said step of transmitting the package identifier and second secret is by way of a hyperlink to the system host server.

5. The method of claim 4 wherein said second secret is embedded within the hyperlink as a hypertext fragment identifier.

6. The method of claim 1 comprising the additional step of at the system host transmitting the encrypted data package and the first secret to the data package recipient.

7. The method according to claim 1 wherein said encryption key is reconstituted from the first secret and second secret by an application programming interface.

8. The method according to claim 7 wherein said application programming interface is invoked by the data package sender or data package recipient using a web browser.

9. The method according to claim 7 wherein said application programming interface is invoked by a desktop email client wherein files are associated with the data package by adding a file attachment to an email message.

10. The method according to claim 7 wherein said application programming interface is invoked locally on the data package sender and data package recipient's computers.

11. The method of claim 1 comprising the additional step of at the system host server storing said data package containing attributes in a server data store.

12. A computer implemented method for securely transferring data between parties using a third party system host comprising the steps of:
providing data for encryption, a data package requestor, a data package sender, a system host server, and a user interface;
at the system host server generating a first secret and attributing said first secret to a data package request made by the data package requestor;
at the data package requestor generating a second secret inaccessible to said system host;
at the data package sender after receiving said first secret from the system host and second secret from the package requestor, combining said first secret and said second secret to generate an encryption key, encrypting the data package and uploading the data package to the system host server; and
at the data package requestor accessing the encrypted data package that has been uploaded to the system host server, retrieving the encrypted data package from the system host server, and after receiving the first secret from the system host reconstituting the encryption key from the first secret and second secret to decrypt the data package.

13. The method of claim 12 comprising the additional step of at the system host server assigning a request identifier to the package request and returning said first secret and request identifier to the data package sender.

14. The method of claim 12 comprising the additional step of at the system host server associating the data package request with the identity of the data requestor.

15. The method according to claim 12 comprising the additional step of at the data package requester transmitting the second secret and request identifier to the data package sender by way of a hyperlink to the system host server.

16. The method of claim 15 wherein the second secret is embedded within the hyperlink as a hypertext fragment identifier.

17. The method of claim 12 comprising the additional step of at the data package sender transmitting the request identifier to the system host server and creating a data package.

18. The method of claim 12 comprising the additional step of at the system host server assigning attributes to the data package selected from the group consisting of a new package identifier, a new first secret and the original request identifier, and transmitting said first secret and package identifier to the data package sender.

19. The method according to claim 12 wherein said encryption key is generated and reconstituted from the first secret and second secret by an application programming interface.

20. The method according to claim 19 wherein said application programming interface is invoked by the data package sender or data package requestor using a web browser.

21. The method according to claim 19 wherein said application programming interface is invoked by a desktop email client wherein said data package request is initiated from within said email client.

22. The method according to claim 19 wherein said application programming interface is invoked locally on the data package sender and data package requestor's computers.

23. The method of claim 12 comprising the additional step of at the system host server storing said data package containing attributes in a server data store.

24. The method of according to claim 12 wherein said data package requestor is registered and said data package sender is unregistered to the system.

25. A system for securely transferring data between parties using a third party system host, the system comprising:
a data package sender, a data package recipient, and a system host server;
a first memory having stored therein computer-executable instructions and a first computer processor that executes the computer-executable instructions configured to assign a data package identifier and a first secret to a data package and transmit said first secret and package identifier to said data package sender;
a second memory having stored therein computer-executable instructions and a second computer processor that executes the computer-executable instructions configured to generate a second secret, combine said second secret with said first secret to generate an encryption key to encrypt said data package; and
a third memory having stored therein computer-executable instructions and a third computer processor that executes the computer-executable instructions configured to receive said first secret from said first memory and first computer processor and said second secret from said second memory and second computer processor and combine said first secret and said second secret to reconstitute the encryption key and decrypt the data package.

26. The system according to claim 25 wherein said system host comprises a server and a data store.

27. The system according to claim 25 wherein said second memory and a second computer processor transmits said second secret to said third memory and third computer processor.

28. The system according to claim 25 wherein said first, second and third memory and computer processor each further comprise an application programming interface.

29. The system according to claim 25 wherein said first, second, and third memory and computer processors communicate through a network.

30. The system according to claim 28 wherein said application programming interfaces are invoked using a web browser.

31. The method according to claim 25 wherein said application programming interfaces are invoked by a desktop email client.

32. The system according to claim 25 wherein said application programming interfaces are invoked locally on the first, second, and third computers.
